(19) United States
(12) Patent Application Publication
(10) Pub. No.: US 2014/0136254 A1
(43) Pub. Date: May 15, 2014

(54) DETERMINING WHETHER TO USE CROWDSOURCING FOR A SPECIFIED TASK

(71) Applicant: INTERNATIONAL BUSINESS MACHINES CORPORATION, Armonk, NY (US)

(72) Inventors: Rajarshi Das, Armonk, NY (US); Maja Vukovic, New York, NY (US)

(73) Assignee: INTERNATIONAL BUSINESS MACHINES CORPORATION, Armonk, NY (US)

(21) Appl. No.: 13/676,406

(22) Filed: Nov. 14, 2012

(51) Int. Cl. G06Q 10/06

(52) U.S. Cl. CPC G06Q 10/06311; G06Q 10/063112
USPC 705/7.14; 705/7.13

(57) ABSTRACT

An embodiment of the invention, directed to a method, is associated with a workflow process comprising one or more discrete tasks. The method includes the step identifying a specified one of the tasks that may be performed by crowdsourcing. The method further includes defining a specified metric, which comprises a measure of benefit provided by using crowdsourcing to perform the specified task, or comprises a cost of using crowdsourcing to perform the specified task, selectively. The method further includes determining whether at least a given criterion has been met, wherein the given criterion is related to the specified metric. The specified task is then performed using crowdsourcing, only after determining that the given criterion has been met.

### BACKGROUND

1. Field

The invention disclosed and claimed herein generally pertains to a workflow process, wherein the process includes one or more specified tasks that could each be carried out by crowdsourcing. More particularly, the invention pertains to a method and system for readily determining whether or not to use crowdsourcing for each of the specified tasks.

2. Description of the Related Art

As is known by those of skill in the art, Web 2.0 technologies have significantly enhanced interactive information sharing and collaboration over the Internet. This has enabled crowdsourcing to develop as an increasingly popular approach for performing certain kinds of important tasks. In a crowdsourcing effort or procedure, a large group of organizations, individuals and other entities that desire to provide pertinent services, such as a specific community of providers or the general public, are invited to participate in a task that is presented by a task requester.

Crowdsourcing tasks are typically atomic elements of larger business or other workflow processes, which may or may not be entirely crowdsourced. The crowdsourced tasks frequently require further coordination, such as integration with other tasks of the process, result coordination, and iterative invocation.

Previously, crowdsourcing tasks were manually created, uploaded and coordinated by the task owner or requester. Little or no attention was given to integrating crowdsourcing as a part of a larger business process, or of the effect of crowdsourcing on the actual end to end execution of the entire workflow of the larger process. Thus, crowdsourcing tasks as presently used tend to be isolated from the overall business process.

### SUMMARY

Embodiments of the invention are generally directed to determining how crowdsourcing may be integrated into a larger workflow process, and also to deciding whether to use crowdsourcing for different individual tasks included in the workflow. One embodiment of the invention, directed to a method, is associated with a workflow process comprising one or more discrete tasks. The method includes the step of identifying a specified one of the tasks that may be performed by crowdsourcing. The method further includes defining a first metric, a second metric or both a first metric and a second metric, selectively, wherein the first metric comprises a measure of benefit provided by using crowdsourcing to perform the specified task, and the second metric comprises a cost of using crowdsourcing to perform the specified task. The method further includes determining whether at least a given criterion has been met, wherein the given criterion is related to a value of the first metric, to a value of the second metric, or to values of both the first and second metrics, selectively. The specified task is then performed using crowdsourcing, only after determining that the specified criterion has been met.

### BRIEF DESCRIPTION OF THE SEVERAL VIEWS OF THE DRAWINGS

FIG. 1 is a schematic diagram showing a workflow process, which comprises an environment in which embodiments of the invention can be implemented.

FIG. 2 is a flowchart showing steps for a method comprising an embodiment of the invention.

FIG. 3 is a schematic diagram showing an exemplary model for assessing the use of crowdsourcing in executing tasks of FIG. 1 that are arranged in a sequence.

FIG. 4 is a schematic diagram showing an exemplary model for assessing the use of crowdsourcing in executing tasks of FIG. 1 that are arranged in a parallel relationship.

FIG. 5 shows a diagram and tables for illustrating aspects of an embodiment of the invention.

FIG. 6 shows a diagram and tables for illustrating further aspects of an embodiment of the invention.

FIG. 7 is a block diagram showing a network of data processing systems in which an embodiment of the invention may be implemented.

FIG. 8 is a block diagram showing a computer or data processing system that may be used in implementing embodiments of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

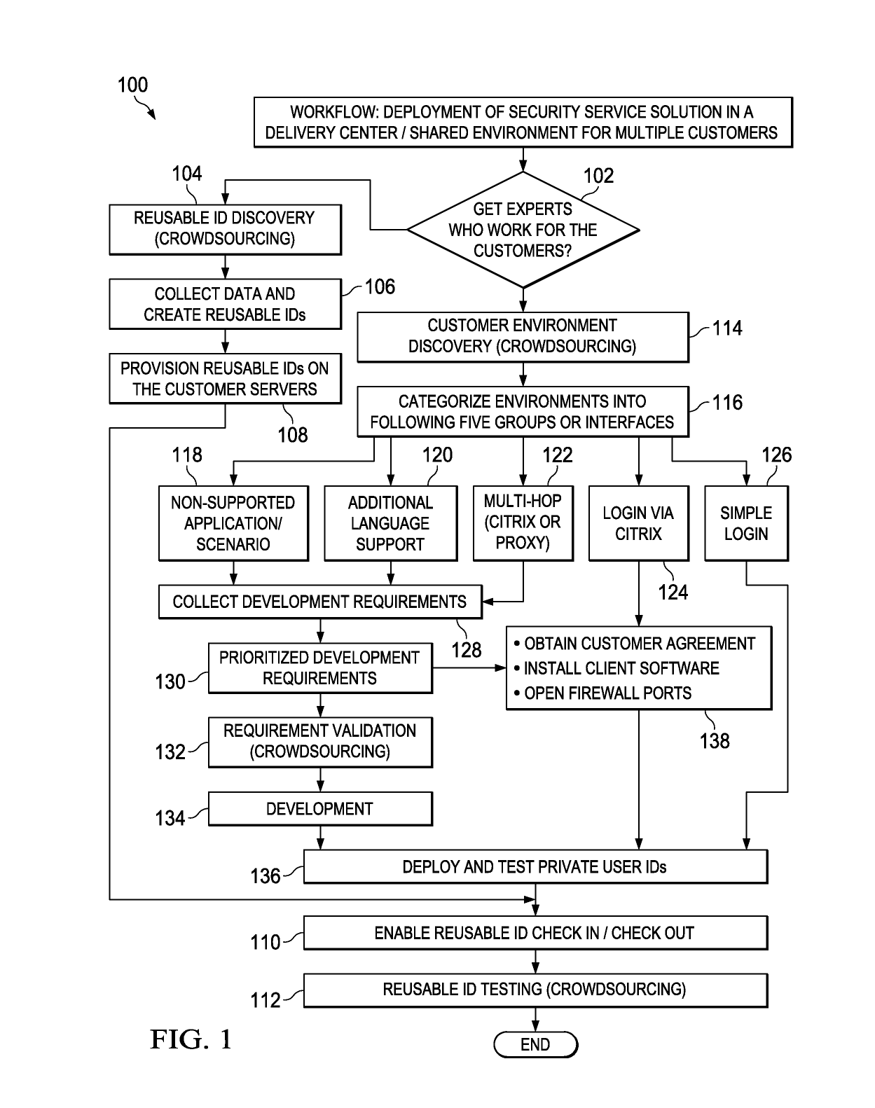

Referring to FIG. 1, there is shown a workflow process 100, which comprises an exemplary environment in which an embodiment of the invention can be implemented. Workflow process 100 more particularly comprises multiple tasks 102-138, which are arranged in relation to one another as shown by respective arrows or flowpaths of FIG. 1. Moreover, some of these tasks, and specifically tasks 104, 112, 114 and 132, are initially considered to be suitable for execution or performance by crowdsourcing. Accordingly, an embodiment of the invention is used to determine whether crowdsourcing, rather than some other method, should be used to execute each of these tasks, in the overall workflow of process 100. It is to be emphasized that process 100 is used only as an example, and the invention is by no means limited thereto.

Workflow process 100 is directed to deployment of a security service solution in a delivery center, or shared hosting environment that provides software as a service for multiple clients or customers. For task 102, it is necessary to identify and acquire subject matter experts (SMEs) who work for respective customers. Workflow process 100 can flow from task 102 to either task 104, or task 114.

Task 104, which is one of the possible tasks to be crowdsourced, is concerned with reusable identity (ID) discovery. This is the process of discovering existing access rights (i.e., user IDs currently in effect) on customer machines. The discovered user IDs may then be used to provide user IDs that can be reused by the original users, and also shared or assigned to other users.

At task 106, the ID data acquired by discovery task 104 is collected and used to create reusable user IDs. Customer servers are provided with reusable IDs at task 108. The workflow of process 100 then proceeds to task 110, which enables reusable IDs to be checked in and checked out.

Referring further to FIG. 1, there is shown task 114 comprising customer environment discovery. This task requires, for a given customer, discovering all the servers, their platforms, installed software, network topology, firewalls, logon methods and the like for that customer. Thus, task 114 provides a technical assessment of infrastructure details of the hosting environment that serves the given customer. As stated above, task 114 is also one of the tasks being considered for crowdsourcing.

Following task 114, task 116 is carried out, to categorize each host environment into one of five groups or interfaces. These groups are shown as groups 118-126, respectively.

The host environments of group 118 have user interfaces wherein application software is not supported by the vendor of such software. Environments of group 120 may have elements in a different language, and thus require additional language support. In environments of group 122, information is passed along by multiple servers in a multi-hop arrangement, such as by using one or more proxy servers or Citrix. Citrix is a means for directly sending a display from a remote desktop or other computer to another location.

FIG. 1 shows that for host environments of groups 118, 120 and 122, the workflow process 100 is directed to task 128. For each of these groups, task 128 collects development requirements. At task 130 the development requirements are prioritized, and the requirements are validated by task 132. As stated above, task 132 is to be considered for crowdsourcing. Development takes place at task 134, and task 136 deploys and tests non-public user IDs. The workflow then proceeds to task 110.

FIG. 1 further shows login via Citrix for host environments of group 124, and shows simple login for environments of group 126. For group 126 the workflow goes directly to task 136, and goes to task 138 for group 124. Task 138 obtains customer agreements, installs client software, and opens firewall ports.

Following task 110, the workflow process goes to task 112, which provides for reusable ID testing. This ensures that new, shared or assigned IDs are functional. This task is also to be considered for crowdsourcing. After task 112, the workflow process 100 ends.

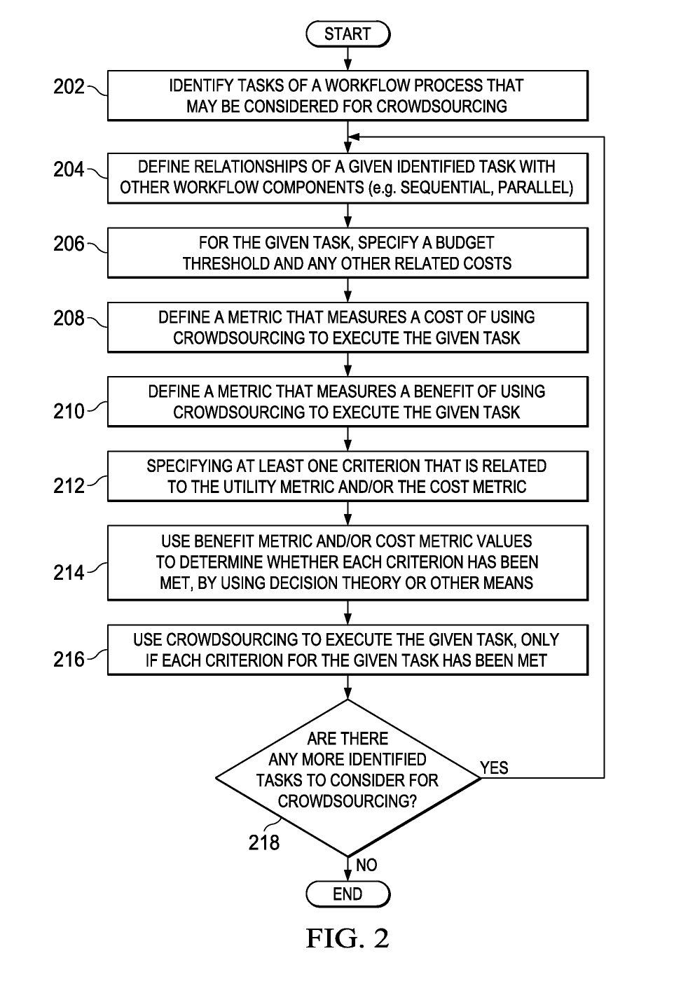

Referring to FIG. 2, there are shown steps for a method comprising an embodiment of the invention. At step 202, tasks of the workflow process that appear to be good candidates for crowdsourcing are identified for consideration. Examples of such tasks are the tasks 104, 112, 114 and 132 of workflow process 100.

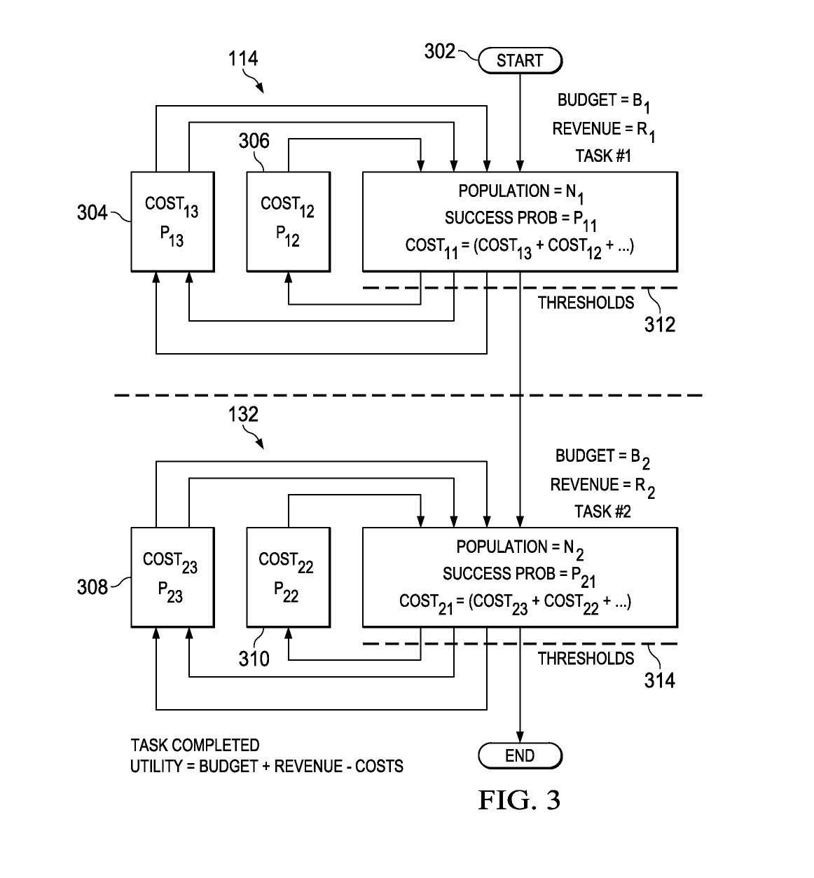

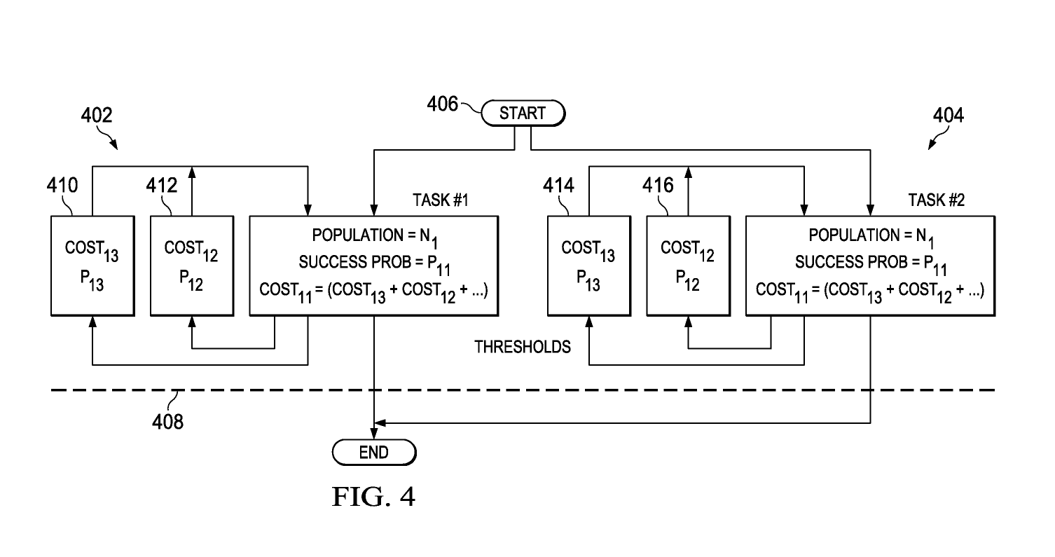

Step 204 defines the relationship between a task identified at step 202, and other tasks or components of the workflow process. For example, an identified task could have a sequential relationship with another task. In this situation, one of the tasks could not be started until the other task was completed. Another relationship could be a parallel relationship, wherein two or more tasks could each start independently of each other. Sequential and parallel relationships between tasks of a workflow are discussed hereinafter in further detail, in connection with FIGS. 3 and 4, respectively.

At step 206 a budget threshold, and any other costs that would be incurred by crowdsourcing a given task, are specified. An example of one such cost is provided in connection with FIGS. 3 and 4. At step 208, a metric is defined for use in measuring a cost of crowdsourcing the given task, wherein the metric could be a monetary amount, or could be a period of time, by way of example.

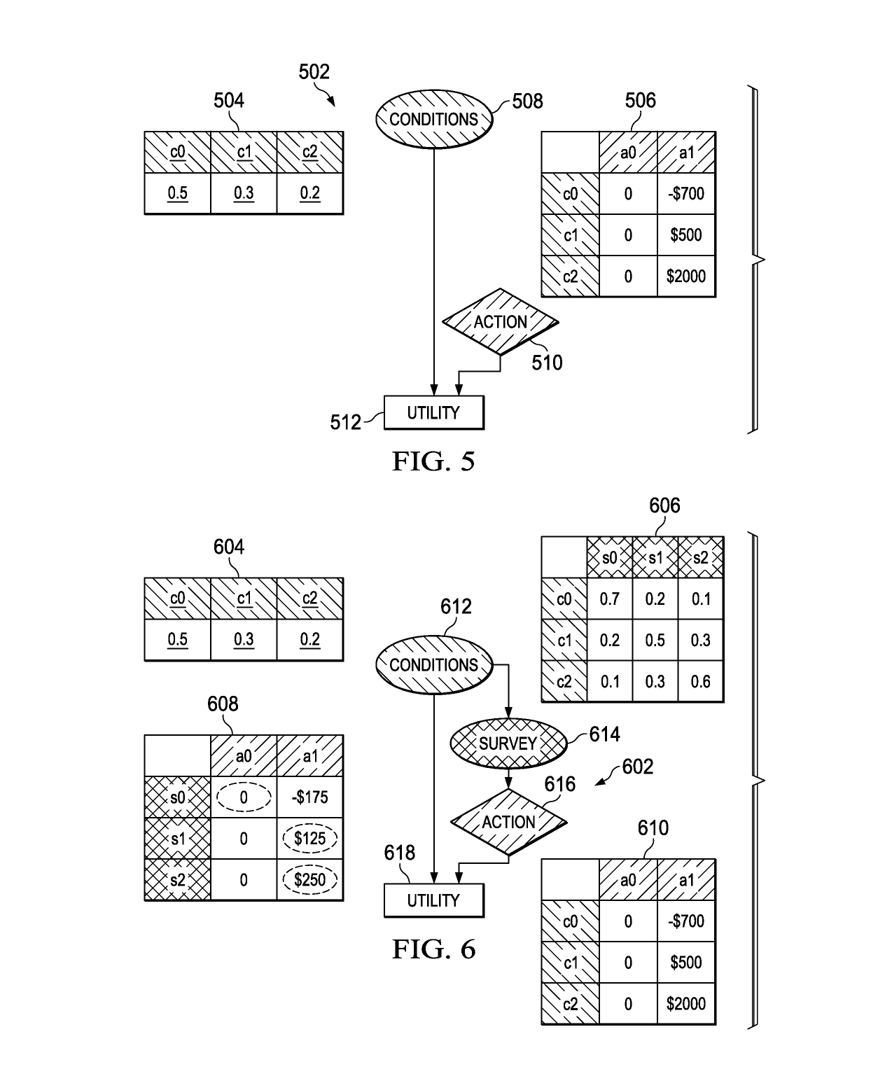

Step 210 of FIG. 2 defines a metric for measuring a benefit, which is expected to be realized if crowdsourcing is used to execute a given task. An example of utility as a benefit metric is provided in connection with FIGS. 5 and 6.

Step 212 of the method of FIG. 2 specifies at least one criterion that is related to the benefit metric, the cost metric, or to both metrics. For example, the criterion could be that the benefit metric is no less than a prespecified minimum value or threshold. Alternatively, the criterion could be that the cost metric is no greater than a prespecified maximum value. Yet another criterion could be provided by a specified function or other relationship that considered both the benefit and cost metric values. Also, for some embodiments of the invention, two or more criteria could be specified, wherein each criterion was related to one or both of the benefit and cost metrics.

At step 214, values of the benefit metric and/or the cost metric are used to determine whether or not each criterion specified at step 212 has been met for the given task. Decision theory could be used for this step, as described hereinafter in connection with FIGS. 5 and 6. In accordance with step 216, crowdsourcing is used to execute a given task if and only if each criterion specified for the given task has been met or realized.

At decision step 218, it is decided whether or not there are any remaining identified tasks to consider for crowdsourcing. If there are, the method of FIG. 2 returns to step 204, and if not the method ends.

Referring to FIG. 3, there is shown task 114 and task 132 of process 100 in a sequential relationship, for purposes of illustration. Tasks 114 and 132 are also referred to more generically in FIG. 3 as Task #1 and Task #2, respectively. Upon receiving a start instruction 302, task 114 is carried out by crowdsourcing, and more specifically is performed by each of multiple agents who have all been assigned task 114. FIG. 3 represents two of these agents as 304 and 306, respectively.

When task 114 is completed by each participating agent, task 132 is initiated. Task 132 is likewise carried out by each of multiple agents who have all been assigned task 132. When task 132 is completed by all agents participating therein, the sequential arrangement of tasks 114 and 132 ends. FIG. 3 represents two of the agents for task 132 as agents 308 and 310, respectively.

In determining whether to use crowdsourcing for a given task or component of a workflow process such as workflow 100, it is useful to allocate a portion of the overall budget for the workflow to each of the tasks. Thus, FIG. 3 shows task 114 allocated a budget B₁, and shows task 132 allocated a budget B₂. Moreover, it may be anticipated that the workflow process will generate an amount of revenue. If so, the portion of the revenue can also be allocated to each component or task of the workflow. Accordingly, FIG. 3 shows task 114 allocated a revenue R₁, and task 132 allocated a revenue R₂.

Referring further to FIG. 3, it is to be appreciated that executing each of the tasks 114 - 132 as a crowdsourcing task will have an associated cost. More particularly, for each task, a cost will be incurred for each agent assigned to that task. FIG. 3 shows that task 114 has a population of N₁, indicating that the task thereof has been assigned to each of N₁ agents for execution. Also, each of these agents has a specified cost. Thus, the cost of agent 304 is Cost₁₃ and the cost of agent 306 is Cost₁₂. The total Cost₁₁, of carrying out task 114 by means of crowdsourcing, is the cumulative cost for all agents N₁. That is, Cost₁₁=(Cost₁₃+Cost₁₂+ . . . ).

For task 132, the agent population is N₂, the cost of agent 308 is Cost₂₃ and the cost of agent 310 is Cost₂₂. The total Cost₂₁ of using crowdsourcing to execute task 132 is Cost₂₁=(Cost₂₃+Cost₂₂+ . . . ).

FIG. 3 shows that a benefit in using crowdsourcing to complete a task can be defined as the sum of the budget and revenue allocated to that task. Thus, for task 114 the benefit would be B₁+R₁, and the benefit for task 132 would be B₂+R₂. FIG. 3 further shows that the utility (U) of a task is defined as the sum of the budget and revenue minus the cost, that is, Utility=Budget+Revenue−Cost. In one embodiment of the invention, both the benefit and cost metrics of the task could be used as a criterion for deciding whether or not to use crowdsourcing to execute that task. For example, crowdsourcing could be used only if the cost of the task is no greater than the sum of the budget and revenue amounts thereof. Another exemplary criterion could be determined by the cost metric alone, wherein a task would only be considered for crowdsourcing if the cost thereof did not exceed a prespecified amount.

In a further embodiment of the invention pertaining to FIG. 3, it could be important that a minimum percentage or portion of the population of agents who are assigned to the crowdsourcing task each completes the task successfully, or returns an acceptable response. For example, it could be that the task requires each agent to answer a series of questions about something they are familiar with, and then return their respective sets of answers. The crowdsourcing task would be considered successful, only if a prespecified minimum percentage of the agents assigned to the task returned meaningful sets of answers. If the agent population was 100 and the percentage was 50%, by way of example, at least 50 sets of answers that were meaningful or useful would need to be returned to the crowdsourcing task requester.

This required minimum of useful results for a task comprises a task threshold. FIG. 3 shows task 114 having a threshold 312, and further shows task 132 having a threshold 314. Moreover, FIG. 3 shows each agent for a task assigned a probability that he or she will complete the task successfully. This probability for an agent is determined by considerations such as the skill level of the agent, the agent's availability, and the agent's prior performance in regard to similar crowdsourcing tasks.

FIG. 3 shows that the probability of success of agents 304 and 306, in regard to task 114 is P₁₃ and P₁₂, respectively. The overall probability of success P₁₁ for this task is determined from the probability values for each agent of the population N₁. In like manner, the probability of success of agents 308 and 310, in regard to task 132 is P₂₃ and P₂₂, respectively. The overall probability of success for task 132 is P₂₁.

The probability of success computed for a task could also be used as a criterion for determining whether or not the task should be crowdsourced. For the above example of requiring successful completion of the task by at least 50% of 100 agents, the task would be submitted for crowdsourcing only if the determined probability of success indicated that the minimum requirement of 50 successful completions would be met.

In the arrangement of FIG. 3, task 114 could be crowdsourced by assigning the task to each of the N₁ agents at the same time. However, task completion results may be returned by different agents at different times. Thus, the time needed to complete task 114, by receiving the minimum number of acceptable results required by the task threshold, could be quite unpredictable. However, task 132 could not be started until task 114 was finished, due to the sequential relationship of these tasks. It may be important to consider the effect of this relationship on the overall workflow process, when deciding whether or not to use crowdsourcing for particular tasks in the workflow.

Referring to FIG. 4, there are shown tasks 402 and 404 that are connected in a parallel relationship. Tasks 402 and 404 may comprise two particular tasks of workflow 100, and are also referred to in FIG. 4 as Task #1 and Task #2, respectively. In the parallel arrangement of FIG. 4, both tasks can be started at the same time, by a start instruction 406. Each task can then proceed and come to an end, independently of the other task. Tasks 402 and 404 also have the same threshold 408.

FIG. 4 further shows that the agent population N₁ of task 402 includes agents 410 and 412, and the population N₁ of task 404 includes agents 414 and 416. Agents 410 and 414 both have a Cost₁₃ and a probability of success P₁₃. Agents 412 and 416 both have a Cost₁₂ and a probability of success of P₁₂. The total Cost₁₁ of each task is the cumulative cost for each of its agents, and its probability of success is P₁₁.

In the example of FIG. 3, the crowdsourcing task assigned to each of multiple agents for execution will be successful only if a prespecified percentage of the agents each complete the task successfully. This example of crowdsourcing is considered to be applicable for a number of different significant situations. Accordingly, it is important to provide a tool or mechanism to determine, in advance, the probability that the results of crowdsourcing will meet the required minimum threshold level.

One such tool is found in connection with decision theory. Decision theory provides that the Expected Utility (EU) for a decision problem D, given an action a, is EU[D[a]]=Sum_x P(x|a) U(x,a). In this relationship, x is a state or condition of the world. The action a is selected to maximize the value of EU, that is, a*=argmax_a EU_{{x,a}} [D[a]].

Referring to FIG. 5, there is shown a simplified diagram 502 and tables 504 and 506 for illustrating a use of decision theory in connection with an embodiment of the invention. More particularly, FIG. 5 pertains to an example wherein it is necessary to make a decision to either use or not use crowdsourcing to perform a given task. In the example, success is determined by the percentage of agents who each perform the task successfully. However, this cannot be known in advance. Thus, decision theory as described above is used in making the decision.

Table 504 of FIG. 5 contains a state or condition variable c, which can have the values c0, c1 and c2. Table 504 shows exemplary values of c0, c1 and c2 to be 0.5, 0.3 and 0.2, respectively. The variable c is a random variable which represents the probability that the required number of agents will successfully perform the given task are good (2), fair (1), or poor (0). The probability values shown by table 504 can be determined from a function P (c), which is derived from certain considerations or information about the agents to be used for crowdsourcing, such as those described above in connection with FIG. 3.

Table 506 of FIG. 5 contains action variable a, which can have only a value a0 or a1. These values represent the actions to not use crowdsourcing, and to use crowdsourcing, respectively. In accordance with decision theory, EU(a), the expected utility as a function of action variable a, is as follows:

EU(a)=Sum, P(c)*U(c,a) Equation (1)

In Equation (1) U (c,a) is a function of both the variables c and a. Table 506 comprises a matrix, which shows values of U (c, a) for different values of c and a. It is to be emphasized that U(c,a) is based upon, and is closely related to, the concept that Utility=Budget+Revenue−Cost, as defined in FIG. 3.

Diagram 502 of FIG. 5 depicts conditions 508 and actions 510 combining to provide the expected utility 512. In accordance with decision theory, Equation (1) is used to select the decision which maximizes expected utility EU (a). To compute EU (a), values of c0, c1 and c2 given in table 504 are multiplied by the respective values at the corresponding positions of the a0 column of table 506, and the resulting products are then added. Since each a0 value is zero, EU (a0) is also zero.

To compute EU (a1), the values of c0, c1 and c2 given in table 504 are multiplied by the respective values at the corresponding positions of the al column of table 506, and the resulting products are then added. This computation is as follows:

EU(a1)=0.5*−700+0.3*500+0.2*2000=$200

Since the value of EU (a1) is greater than the value of EU (a0), it is determined to take action a1, so that crowdsourcing will be used . The values of the al column of table 506 are shown in dollars, to emphasize that Utility for this embodiment of the invention is measured in monetary terms. Values are also shown to be on the order of 100 dollars, which is considered to be plausible for the embodiment of the invention.

Referring to FIG. 6, there is shown a diagram 602 and tables 604-610 that pertain to an embodiment of the invention that modifies the example of FIG. 5. Table 604 is identical to table 504 of FIG. 5, and table 610 is identical to table 506 thereof. In the modification of FIG. 6, additional information is initially obtained from crowdsourcing agents who would be asked to perform a specified task. The additional information is then used to enhance accuracy in determining the probability that the number of agents completing the specified task would exceed the prespecified threshold.

It is to be appreciated that the gathering of this information could itself be another crowdsourcing task. Alternatively, or in addition, the information would be obtained from historical records of agents' behavior in previous crowdsourcing tasks. In either case, there could be a cost associated in obtaining this information.

To obtain the additional information as another crowdsourcing task, a survey or questionnaire is sent to each prospective crowdsourcing agent. The survey would present questions pertaining to the likelihood that respective agents would successfully carry out the specified task. FIG. 6 shows exemplary survey result values s0, s1, s2, which could be the cumulative results of different groups of returned surveys. In this embodiment, expected utility EU is a function of both the action variable a and survey result value s. This EU function is as follows:

EU(s,a)=Sum, P(c) P(s|c) U(c,a) Equation (2)

Diagram 602 illustrates that survey results 614 are now combined with conditions 612 and actions 616 to determine expected utility 618 in regard to a specified task. Function P(c) of Equation (2) provides values for table 604, and function U(c,a) provides monetary values for table 610, as described above in connection with table 506 for FIG. 5. Function P(s|c) of Equation (2) provides values for table 606.

Table 608 depicts exemplary values of EU(s,a) determined by Equation (2) for different values of s and a. Table 608 shows that for the s value s0, the Expected Utility value for a0 is zero. This is greater than the Expected Utility value for a1, which is a negative number −175. Thus, for the survey result s0, the action variable a0 should be used, that is, the action to not use crowdsourcing for the specified task.

For the survey result values s1 and s2, Expected Utility is greater for the action value a1 than for a0. Accordingly, based on these survey results, the action to be taken is to use crowdsourcing for the specified task, for both the s1 and s2 survey results. By adding the maximum value of EU (s,a) for each survey result, that is, Max EU (s,a), a maximum cost of carrying out the survey to obtain results s0, s1 and s2 can be determined. Accordingly, Max EU (s,a)=0+125+250=$375. As described above in connection with FIG. 5, the expected utility for the action al, to use crowdsourcing, is EU (a1)=200. The Value of Information provided by the surveys is therefore 375−200=$175. It follows that this value must be greater than the cost of the surveys, in order to carry out the survey effort.

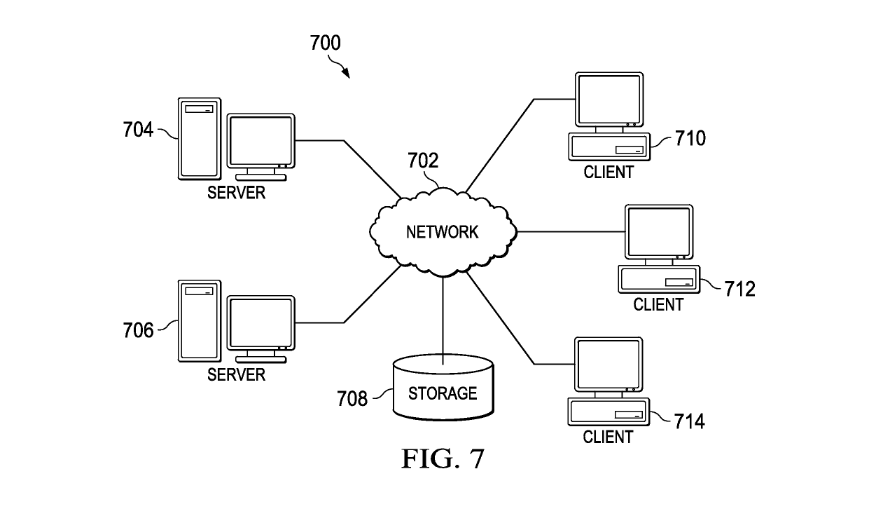

FIG. 7 is a pictorial representation of a network of data processing systems in which illustrative embodiments of the invention may be implemented. Network data processing system 700 is a network of computers in which the illustrative embodiments may be implemented. Network data processing system 700 contains network 702, which is the medium used to provide communications links between various devices and computers connected together within network data processing system 700. Network 702 may include connections, such as wire, wireless communication links, or fiber optic cables.

In the depicted example, server computer 704 and server computer 706 connect to network 702 along with storage unit 708. In addition, client computers 710, 712, and 714 connect to network 702. Client computers 710, 712, and 714 may be, for example, personal computers or network computers. In the depicted example, server computer 704 provides information, such as boot files, operating system images, and applications to client computers 710, 712, and 714. Client computers 710, 712, and 714 are clients to server computer 704 in this example. Network data processing system 700 may include additional server computers, client computers, and other devices not shown.

Program code located in network data processing system 700 may be stored on a computer-recordable storage medium and downloaded to a data processing system or other device for use. For example, program code may be stored on a computer-recordable storage medium on server computer 704 and downloaded to client computer 710 over network 702 for use on client computer 710.

In the depicted example, network data processing system 700 is the Internet with network 702 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 700 also may be implemented as a number of different types of networks, such as, for example, an intranet, a local area network (LAN), or a wide area network (WAN). FIG. 7 is intended as an example, and not as an architectural limitation for the different illustrative embodiments.

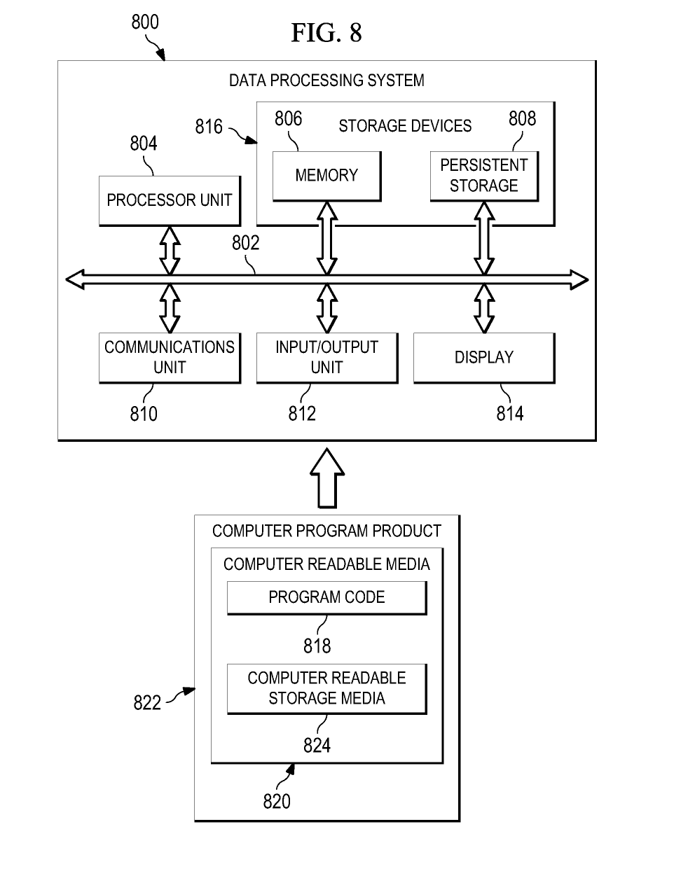

Turning now to FIG. 8, an illustration of a data processing system is depicted in accordance with an illustrative embodiment. The data processing system may be used as one or more of the components for network system 600. In this illustrative example, data processing system 800 includes communications fabric 802, which provides communications between processor unit 804, memory 806, persistent storage 808, communications unit 810, input/output (I/O) unit 812, and display 814.

Processor unit 804 serves to execute instructions for software that may be loaded into memory 806. Processor unit 804 may be a number of processors, a multi-processor core, or some other type of processor, depending on the particular implementation. A number, as used herein with reference to an item, means one or more items. Further, processor unit 804 may be implemented using a number of heterogeneous processor systems in which a main processor is present with secondary processors on a single chip. As another illustrative example, processor unit 804 may be a symmetric multi-processor system containing multiple processors of the same type.

Memory 806 and persistent storage 808 are examples of storage devices 816. A storage device is any piece of hardware that is capable of storing information, such as, for example, without limitation, data, program code in functional form, and/or other suitable information either on a temporary basis and/or a permanent basis. Storage devices 816 may also be referred to as computer-readable storage devices in these examples. Memory 806, in these examples, may be, for example, a random access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808.

Communications unit 810, in these examples, provides for communications with other data processing systems or devices. In these examples, communications unit 810 is a network interface card. Communications unit 810 may provide communications through the use of either or both physical and wireless communications links.

Input/output unit 812 allows for input and output of data with other devices that may be connected to data processing system 800. For example, input/output unit 812 may provide a connection for user input through a keyboard, a mouse, and/or some other suitable input device. Further, input/output unit 812 may send output to a printer. Display 814 provides a mechanism to display information to a user.

Instructions for the operating system, applications, and/or programs may be located in storage devices 816, which are in communication with processor unit 804 through communications fabric 802. In these illustrative examples, the instructions are in a functional form on persistent storage 808. These instructions may be loaded into memory 806 for execution by processor unit 804. The processes of the different embodiments may be performed by processor unit 804 using computer implemented instructions, which may be located in a memory, such as memory 806.

These instructions are referred to as program code, computer-usable program code, or computer-readable program code that may be read and executed by a processor in processor unit 804. The program code in the different embodiments may be embodied on different physical or computer-readable storage media, such as memory 806 or persistent storage 808.

Program code 818 is located in a functional form on computer-readable media 820 that is selectively removable and may be loaded onto or transferred to data processing system 800 for execution by processor unit 804. Program code 818 and computer-readable media 820 form computer program product 822 in these examples. In one example, computer-readable media 820 may be computer-readable storage media 824. Computer-readable storage media 824 may include, for example, an optical or magnetic disk that is inserted or placed into a drive or other device that is part of persistent storage 808 for transfer onto a storage device, such as a hard drive, that is part of persistent storage 808. Computer-readable storage media 824 also may take the form of a persistent storage, such as a hard drive, a thumb drive, or a flash memory, that is connected to data processing system 800. In some instances, computer-readable storage media 824 may not be removable from data processing system 800.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 804 may take the form of a hardware unit that has circuits that are manufactured or configured for a particular use. This type of hardware may perform operations without needing program code to be loaded into a memory from a storage device to be configured to perform the operations.

For example, when processor unit 804 takes the form of a hardware unit, processor unit 804 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 818 may be omitted because the processes for the different embodiments are implemented in a hardware unit.

In still another illustrative example, processor unit 804 may be implemented using a combination of processors found in computers and hardware units. Processor unit 804 may have a number of hardware units and a number of processors that are configured to run program code 818. With this depicted example, some of the processes may be implemented in the number of hardware units, while other processes may be implemented in the number of processors.

As another example, a storage device in data processing system 800 is any hardware apparatus that may store data. Memory 806, persistent storage 808, and computer-readable media 820 are examples of storage devices in a tangible form.

In another example, a bus system may be used to implement communications fabric 802 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 806, or a cache, such as found in an interface and memory controller hub that may be present in communications fabric 802.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. In association with a workflow process comprising one or more discrete tasks, a method comprising the steps of:
identifying a specified one of the tasks that may be performed by crowdsourcing;
defining a specified metric, which comprises a measure of benefit provided by using crowdsourcing to perform the specified task, or comprises a cost of using crowdsourcing to perform the specified task, selectively;
determining whether at least a given criterion has been complied with, wherein the given criterion is related to the specified metric; and
performing the specified task using crowdsourcing only after determining that the given criterion has been complied with.

2. The method of claim 1, wherein:
the specified metric comprises a monetary cost of performing the specified task by crowdsourcing, and the given criterion requires that a particular monetary limit is not exceeded by the specified metric.

3. The method of claim 1, wherein:
the specified metric comprises a monetary cost of performing the specified task by crowdsourcing, a specified amount of revenue is anticipated from performing the specified task by crowdsourcing, and the given criterion requires that the anticipated revenue amount is not exceeded by the specified metric by more than a prespecified amount.

4. The method of claim 1, wherein:
the specified metric comprises a first period of time required to perform the specified task by crowdsourcing, and the given criterion requires that the first period of time does not exceed a prespecified second period of time.

5. The method of claim 1, wherein:
the given criterion comprises one of a plurality of criteria, wherein each criterion of the plurality must be met in order to perform the specified task using crowdsourcing.

6. The method of claim 1, wherein:
the specified task requires each of multiple agents in an agent population to provide a specified result, the specified metric comprises the number of agents who each provides the specified result, and the given criterion comprises a minimum percentage of agents, of the total number of agents in the population, who each provides the specified result.

7. The method of claim 6, further comprising the step of:
determining a probability that the minimum percentage criterion will be met.

8. The method of claim 7, wherein:
decision theory is used to determine the probability that the minimum percentage criterion will be met.

9. The method of claim 8, further comprising the step of:
using decision theory to compute an expected utility, as a function of the probability that the minimum percentage criterion will be met, and also as a function of action variables to use crowdsourcing, and to not use crowdsourcing, selectively, to perform the specified task.

10. The method of claim 7, further comprising the step of:
acquiring information items from respective agents in the agent population for use in determining the probability that the minimum percentage criterion will be met, wherein the information items are selected from a group consisting of agent skill level, agent availability, and agent prior performance in regard to crowdsourcing tasks.
